(19) United States
(12) Patent Application Publication
(10) Pub. No.: US 2010/0228752 A1
(43) Pub. Date: Sep. 9, 2010

(54) MULTI-CONDITION FILTERING OF AN INTERACTIVE SUMMARY TABLE

(75) Inventors: Allan Folting, Redmond, WA (US); Zixiang Li, Redmond, WA (US); Anatoly V. Grabar, Redmond, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/392,111

(22) Filed: Feb. 25, 2009

(51) Int. Cl. G06F 17/30; G06F 17/00

(52) U.S. Cl. 707/758; 715/227; 707/E17.109; 715/212; 707/705

(57) ABSTRACT

Technologies are described herein for allowing a user of an interactive summary table to specify multi-condition data filters to modify the data displayed in the summary table. A user interface is displayed to the user that allows the user to specify a multi-condition data filter. The specification of the multi-condition data filter includes a set of filter conditions connected by logical operators. One or more filter expressions are parsed from the specification of the multi-condition data filter based on the filter conditions and the logical operators, and the filter expressions are applied to the summary data from which the summary table is displayed.

### BACKGROUND

A summary table is a data summarization tool that allows detailed, transactional source data to be “rolled-up” or summarized at varying levels of detail. Summary table functionality, also known as pivot tables, can be found in data visualization and analysis programs such as spreadsheets programs and data reporting tools. The data analysis program may allow a user to draw the summary table as a grid, specifying data fields from the source data for the row and column labels of the grid as well as the data values summarized in the grid. The data analysis program may then group, sort, count, and/or total the data values in the grid based on the row and column labels extracted from the source data.

The data analysis program may allow the user to specify multiple data fields for the row and/or column labels of the summary table. In this case, the data analysis program traditionally displays the data values summarized hierarchically by the row or column labels based on the order of the data fields specified. The data analysis program may also allow the user to interactively manipulate the summary table, expanding and collapsing row labels or column labels in the hierarchy to display more or fewer data values, depending on the user's requirements.

Some implementations of interactive summary tables may allow the user to limit the data displayed by specifying data filters for the summary table. The data filters may be report level filters, which limit the source data utilized by the data analysis program in building the summary table, or the data filters may be row or column filters, which allow the user to choose which rows or columns are displayed according to the value of the corresponding row or column labels or the data values summarized in that row or column.

Because of limitations in the user interfaces for specifying the data filters, these implementations are generally limited to one filter criteria or condition per row or column, and do not allow for complex data filters containing multiple, additive conditions to be created. Such complex data filters may be necessary when searching for specific pieces of information among a large set of diverse source data. In these cases, the user may have to resort to utilizing database experts to pre-filter the source data by using query expressions or other mechanisms before the data is accessed by the data analysis program. This adds complexity and resources to the reporting process and may result in a specialized summary table that limits the user's ability to interactively manipulate the data displayed.

It is with respect to these considerations and others that the disclosure made herein is presented.

### SUMMARY

Technologies are described herein for allowing a user of an interactive summary table to specify multi-condition data filters to modify the data displayed in the summary table. Utilizing the technologies described herein, a data analysis program may provide a user interface that allows the user to create complex, multi-condition data filters, as well as group and order the conditions of the data filters so that the intended data is displayed in the summary table. This may allow the user to display a particularized subset of data rows or columns in the summary table from a large, diverse set of source data, without having to employ a database expert to pre-filter the source data before it is read by the data analysis program.

According to one embodiment, a user interface is displayed to a user that allows the user to specify a multi-condition data filter. The specification of the multi-condition data filter includes a set of filter conditions connected by logical operators. One or more filter expressions are parsed from the specification of the multi-condition data filter based on the filter conditions and the logical operators, and the filter expressions are applied to the summary data from which the summary table is displayed.

It should be appreciated that the above-described subject matter may be implemented as a computer-controlled apparatus, a computer process, a computing system, or as an article of manufacture such as a computer-readable medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a block diagram showing aspects of an illustrative operating environment and several software components provided by the embodiments presented herein;

FIG. 2 is a screen diagram showing the display of an illustrative summary table, according to embodiments described herein;

FIGS. 3 and 4 are screen diagrams showing examples of a user interface for specifying multi-condition data filters for an interactive summary table, according to embodiments described herein;

FIGS. 5A and 5B are screen diagrams showing another example of a user interface for specifying multi-condition data filters, including the ability to order the conditions of the data filter, according to embodiments described herein;

FIGS. 5A and 5B are screen diagrams showing another example of a user interface for specifying multi-condition data filters, including the ability to order the conditions of the data filter, according to embodiments described herein;

FIGS. 7A and 7B are screen diagrams showing the changes to the display of the summary table based on the ordering of conditions in the multi-condition data filter shown in FIGS. 6A and 6B, respectively, according to embodiments described herein;

FIGS. 8A and 8B are screen diagrams showing another example of a user interface for specifying multi-condition data filters, including the ability to group the conditions of the data filter, according to embodiments described herein;

FIG. 9 is a flow diagram showing one method for applying multi-condition data filters to the display of an interactive summary table; and

FIG. 10 is a block diagram showing an illustrative computer hardware and software architecture for a computing system capable of implementing aspects of the embodiments presented herein.

### DETAILED DESCRIPTION

The following detailed description is directed to technologies for providing multi-condition filtering of data displayed in an interactive summary table. While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

In the following detailed description, references are made to the accompanying drawings that form a part hereof, and that show, by way of illustration, specific embodiments or examples. In the accompanying drawings, like numerals represent like elements through the several figures.

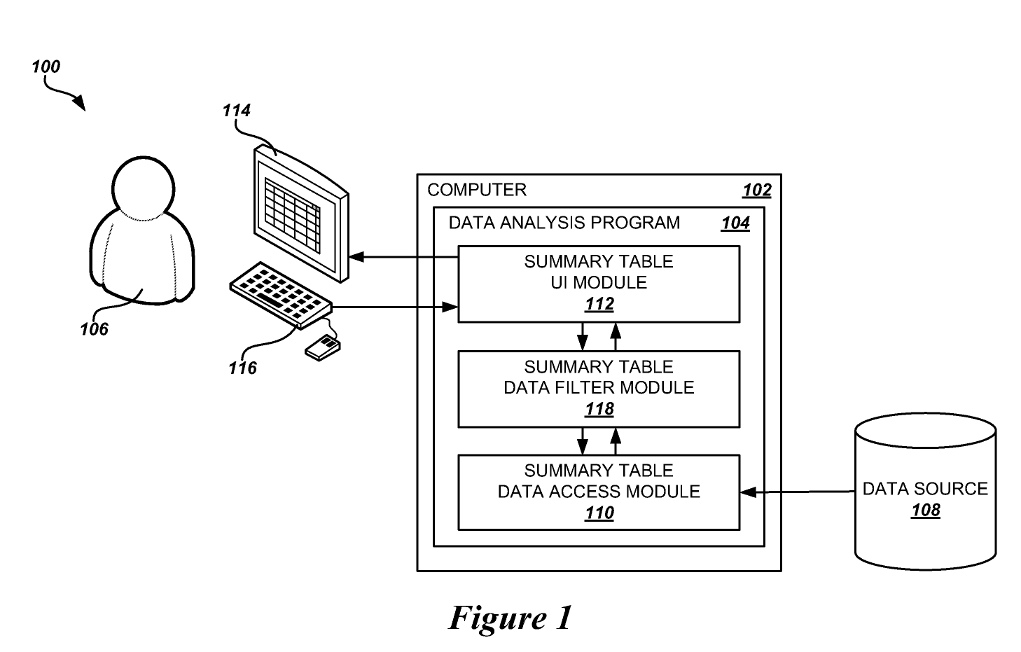

FIG. 1 shows an illustrative operating environment 100 including several software components for providing multi-condition filtering of an interactive summary table, according to embodiments provided herein. The environment 100 includes a computer 102. The computer 102 may be a personal computer (“PC”), a desktop workstation, a laptop, a notebook, a personal digital assistant (“PDA”), an application server, a Web server hosting Web-based application programs, or any other computing device that can execute application programs.

The computer 102 executes a data analysis program 104. The data analysis program 104 is an application program that allows a user 106 of the computer 102 to visualize and manipulate data contained in a data source 108 accessible by the computer. The data analysis program 104 may be a spreadsheet program, such as the MICROSOFT® EXCEL® spreadsheet software from Microsoft Corporation of Redmond, Wash., or the IBM® LOTUS® 1-2-3® spreadsheet software from IBM Corporation of Armonk, N.Y. The data analysis program 104 may also be a data reporting application, such as SAP® BUSINESSOBJECTS™ CRYSTAL REPORTS from SAP, AG of Waldorf, Germany. The data source 108 may be a file system attached to or accessible by the computer 102 and may contain spreadsheet files or other data files. The data source 108 may also be a database or multi-dimensional online analytical processing (“OLAP”) cube containing detailed and/or summarized data which may be queried by the data analysis program 104.

The data analysis program 104 may include a summary table data access module 110 that is operative to retrieve source data from the data source 108 and transform the source data through summarization functions into summary data. A summary table UI module 112 may then display the summary data to the user 106 on a display device 114 connected to the computer 102. The display device 114 may be a computer monitor, a flat-panel display, a digital projector, a printer, a plotter, or any other output device attached to the computer 102. The display device 114 may also be a Web browser application program or other application program executing on a remote computing device accessing the computer 102 over a network. The user may utilize input devices 116 connected to the computer 102 or remote computing device, such as a keyboard, mouse, touchscreen, stylus, or trackball, to control or manipulate the display of the summary table on the display device 114 through the summary table UI module 112.

According to embodiments, the data analysis program also includes a summary table data filter module 118. The summary table data filter module 118 accepts the specification of one or more data filters from the user 106 through a user interface (“UI”) displayed by the summary table UI module 112, and filters the data that is displayed in the summary table accordingly, as will be described in more detail below. It will be appreciated that, while the summary table data access module 110, the summary table data filter module 118, and summary table UI module 112 are described herein as separate modules of the data analysis program 104, these modules are utilized herein to refer to specific functionality of the data analysis program, which may in practice be implemented in more, fewer, or different program modules than those described herein. It is not intended that the description of these modules impart any limitations on the programmatic structure of the data analysis program 104.

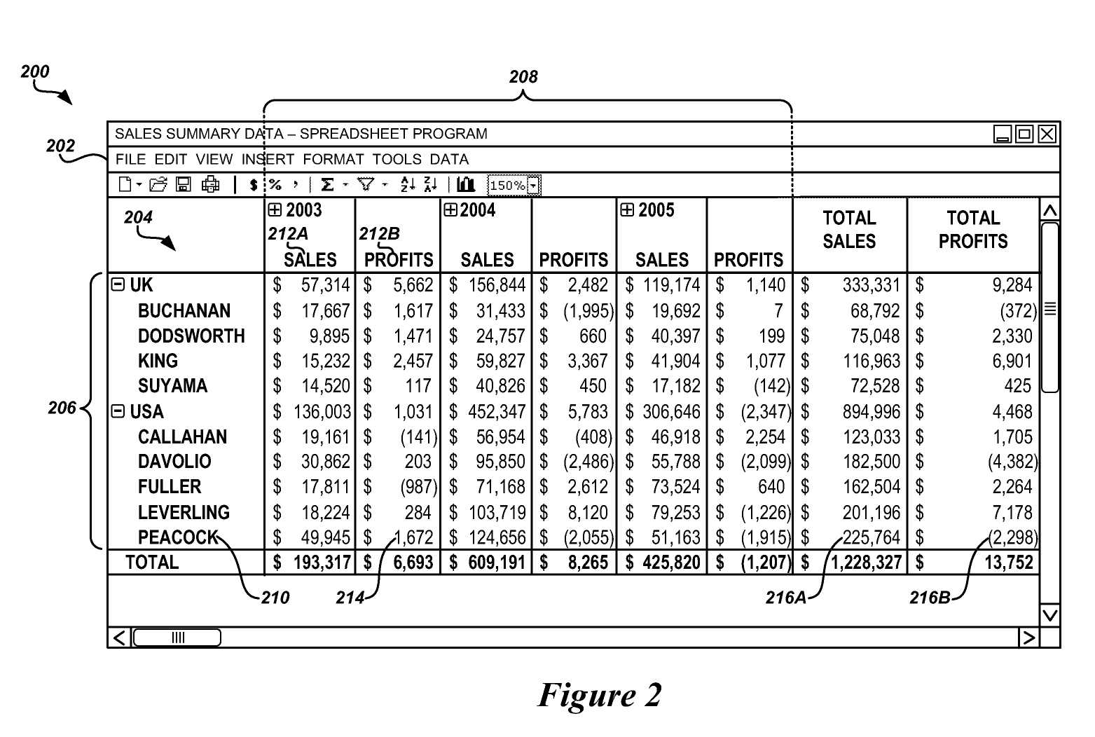

FIG. 2 shows an example screen display 200 of a window 202 containing a summary table 204 rendered by the summary table UI module 112 to the display device 114. The summary table 204 consists of a grid of rows 206 and columns 208 constructed from the source data retrieved from the data source 108 by the summary table data access module 110. In this example, the rows 206 of the summary table 204 are labeled with values from a SALESMAN field in the source data, while the columns 208 of the summary table reflect an ORDER DATE field. For instance, one of the rows 206 shown in FIG. 2 has a SALESMAN row label 210 with the value of “PEACOCK.”

The SALESMAN row labels 210 may rollup to a COUNTRY field from the source data, while the column labels may rollup by YEAR. The summary table 204 also includes two data values fields 212A, 212B, summarized for each row and column label: a SALES data value field 212A and a PROFITS data value field 212B. For example, the data value 214 shown in FIG. 2 may represent the sum of the PROFITS data value field 212B for the SALESMAN “PEACOCK” in the year 2003. In addition, the summary table 204 may include totals for the data values fields 212A, 212B for the entire row and/or column. For example, a “TOTAL SALES” value 216A and a “TOTAL PROFITS” value 216B for the row with the SALESMAN row label 210 of “PEACOCK” is further shown in FIG. 2.

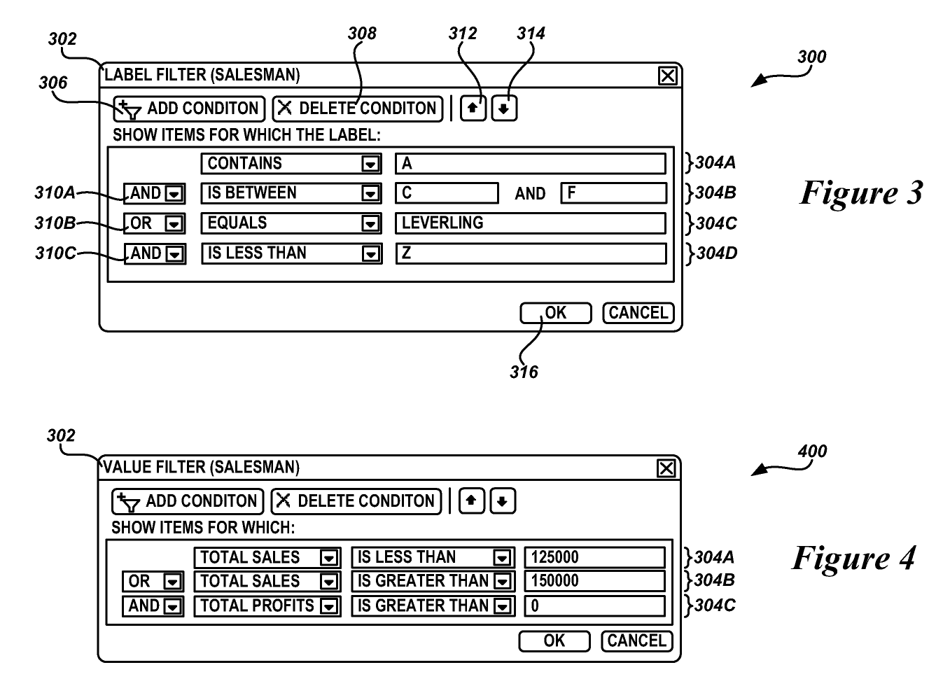

FIG. 3 shows a UI 300 presented by the summary table UI module 112 that allows the user 106 to specify a multi-condition data filter, according to one embodiment. As described above, the data analysis program 104 may provide the user 106 the ability to limit the summary data displayed in the summary table 204 by specifying one or more data filters. For example, the user 106 may specify a data filter on the SALESMAN field to limit the rows 206 displayed in the summary table 204. The UI 300 shown in FIG. 3 comprises a data filter window 302 that allows the user 106 to specify a data filter for the values of the SALESMAN row label 210. The data filter window 302 may be displayed by the summary table UI module 112 as a result of the user 106 selecting a menu item, a toolbar button, or other UI trigger using the input devices 116 connected to the computer 102, for example.

According to one embodiment, the user 106 may specify multiple criteria or filter conditions 304A-304D (referred to herein collectively as filter conditions 304) for the data filter. Additional filter conditions 304 may be added to the data filter window 302 by the user 106 selecting an add condition UI control 306, such as the “ADD CONDITION” button control shown in FIG. 3, using the input devices 116 connected to the computer 102. Similarly, filter conditions 304 may be removed by the user 106 selecting a delete condition UI control 308, such as the “DELETE CONDITION” button control further shown in FIG. 3.

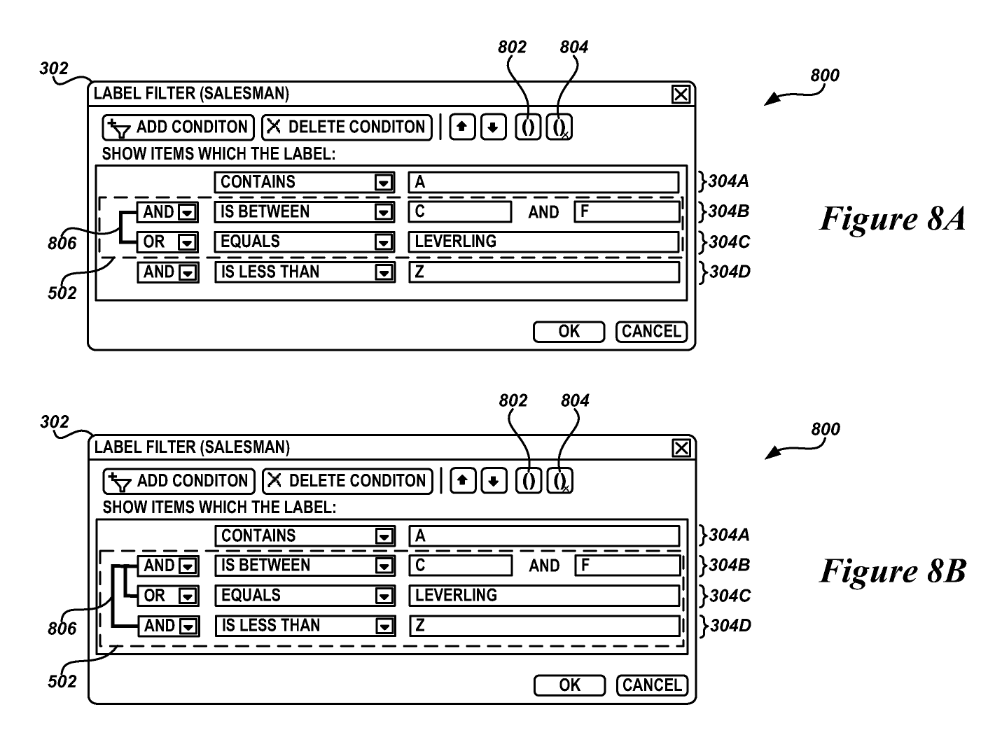

The filter conditions 304 are connected by logical operators which the user 106 may select for each additional condition using a logical operator selection control 310A-310C (referred to herein collectively as logical operator selection control 310). In one embodiment, the user may select an “AND” or an “OR” operator for each additional filter condition 304 added in the data filter window 302. The logical operators connecting the filter conditions 304 determine how the data filters will be applied by the summary table data filter module 118, as will be described in more detail below in regard to FIG. 8. As an example, the data filter window 302 shown in FIG. 3 specifies a data filter that will limit the rows 206 displayed in the summary table 204 to those rows where the value of the SALESMAN row label 210 contains an “A” and where the value of the SALESMAN row label falls alphabetically between “C” and “F”, or where the value of the SALESMAN row label equals “LEVERLING”, and where the value of the SALESMAN row label is alphabetically less than “Z”.

It will be appreciated that the order of evaluation of the logical operators between the filter conditions 304 may have an impact on the corresponding filtering of the summary data that will be applied. According to one embodiment, the logical operators are evaluated in a default order corresponding to the order in which the filter conditions 304 are specified. From the example shown in FIG. 3, this may correspond to a filter expression of:

(((SALESMAN contains “A” AND SALESMAN is between “C” and “F”) OR SALESMAN equals “LEVERLING”) AND SALESMAN is less than “Z”)

In another embodiment, the data analysis program 104 may provide the user 106 with the ability to group filter conditions 304 together in order to modify the order of evaluation of the logical operators, as will be described in more detail below in regard to FIGS. 8A and 8B.

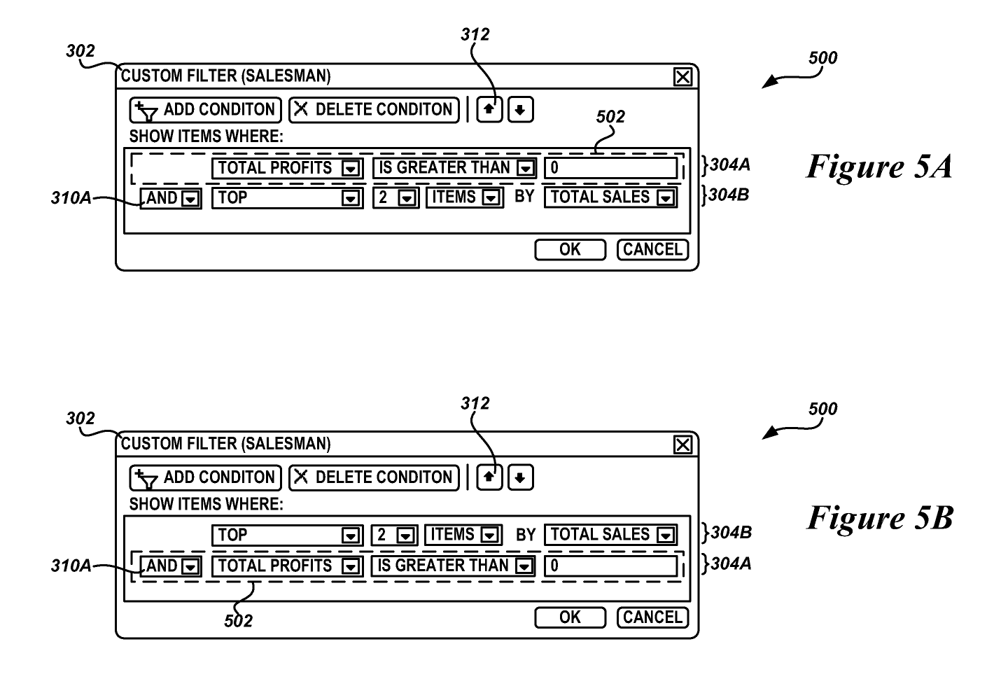

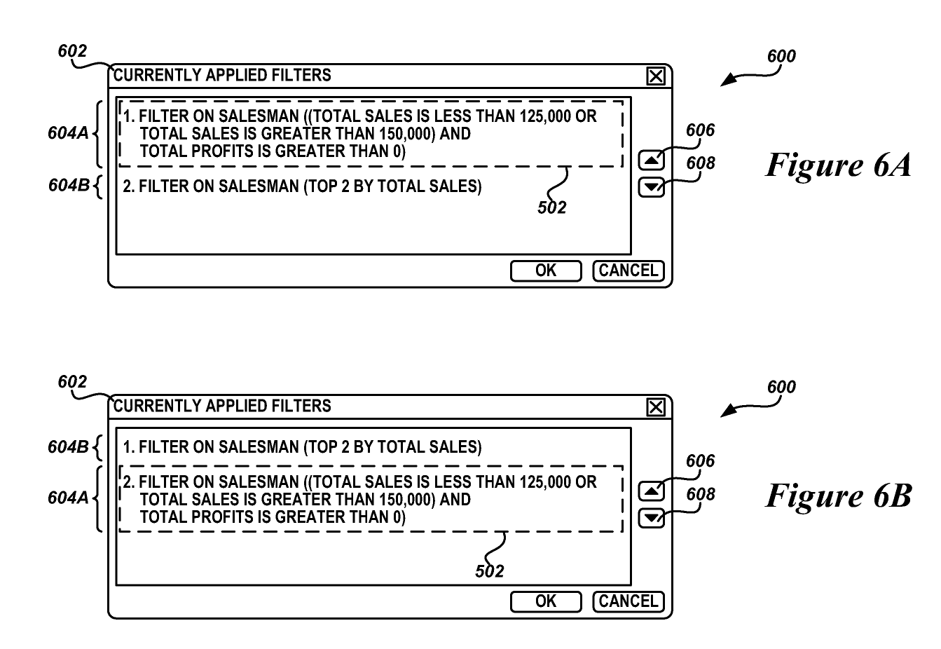

In addition, the data filter window 302 may allow the user 106 to change the order of the filter conditions 304 listed in the window. The user may utilize reorder condition UI controls 312, 314, such as the up and down button controls further shown in FIG. 3, to move a specific filter condition 304 up or down in the listed order, as will be discussed below in regard to FIGS. 5A and 5B. Once the filter conditions 304 have been added, ordered, and connected by logical operators in the data filter window 302, the user 106 may select the OK button control 316 to apply the data filter to the summary data displayed in the summary table 204.

FIG. 4 shows another UI 400 for specifying a multi-condition data filter for the SALESMAN field to limit the rows 206 displayed in the summary table 204, according to a further embodiment. The UI 400 comprises a data filter window 302 that allows the user 106 to specify a data filter having multiple filter conditions 304 related to the total values 216A, 216B corresponding to each SALESMAN row label 210. As shown in FIG. 4, the data filter window 302 specifies a data filter that will limit the rows 206 displayed in the summary table 204 to those rows where the TOTAL SALES value 216A corresponding to the SALESMAN row label 210 is less than 125,000 or greater than 150,000, and where the TOTAL PROFITS value 216B corresponding to the SALESMAN row label 210 is greater than 0.

It will be appreciated that other embodiments of the data filter window 302 may be imagined that allow multi-condition data filters to be specified for the rows 206 or columns 208 of the summary table 204, including, but not limited to, a “top 10” data filter containing multiple “top 10” filter conditions 304 related to the total values 216A, 216B shown in the summary table, or a date range data filter containing multiple date range filter conditions 304 for the ORDER DATE field reflected in the columns of the summary table. In a further embodiment, a custom data filter window 302 may be provided by the summary table UI module 112 that allows the user 106 to specify multiple filter conditions 304 of different types for the same entity, such as the data filter window shown in FIGS. 5A and 5B.

FIG. 5A shows a further example of a UI 500 presented by the summary table UI module 112 that allows the user 106 to specify a multi-condition data filter. The UI 500 comprises a data filter window 302 specifying a first filter condition 304A limiting the rows 206 displayed in the summary table 204 to those rows where the TOTAL PROFITS value 216B corresponding to each SALESMAN row label 210 is greater than 0, and a second filter condition 304B limiting the displayed rows to the SALESMAN row labels 210 having the top two corresponding TOTAL SALES values 216A. In other words, the filter expression for the multi-condition data filter may be logically expressed as:

(TOTAL PROFITS is greater than 0 AND Top 2 items by TOTAL SALES)

As described above in regard to FIG. 3, the data filter window 302 may allow the user 106 to change the order of the filter conditions 304 listed in the window. This may in turn change the resulting rows 206 that are displayed in the summary table 204 when the data filter is applied. For example, the user 106 may select the second filter condition 304B in the data filter window 302 shown in FIG. 5A, as indicated by the selection box 502, by utilizing the input devices 116 connected to the computer 102. If the user then utilizes the “up” reorder condition UI control 312 to move the second filter condition up in the listed order, the filter conditions 304 may then be listed in the data filter window 302 as shown in FIG. 5B. From the order of the filter conditions 304 listed in the data filter window 302 shown FIG. 5B, the corresponding filter expression may be logically expressed as:

(Top 2 items by TOTAL SALES AND TOTAL PROFITS is greater than 0)

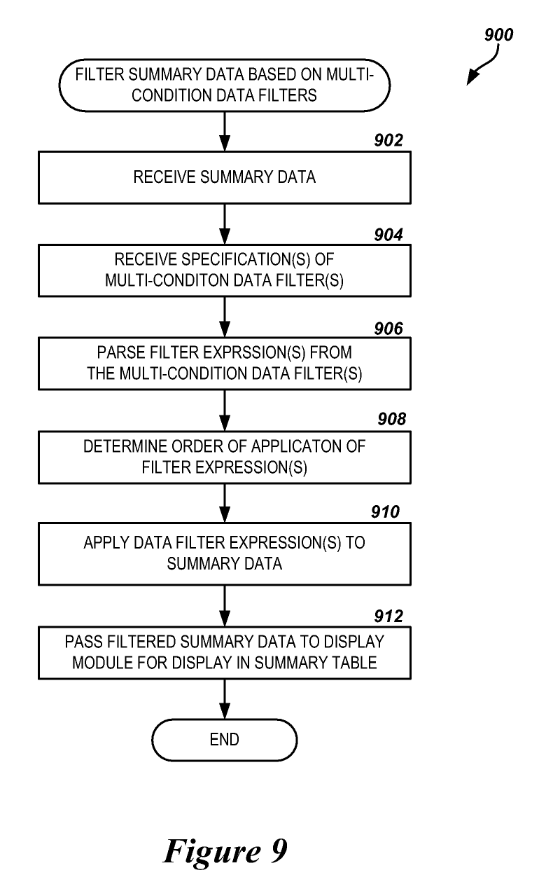

In one embodiment, the above expression and the filter expression corresponding to the multi-condition data filter discussed above in regard to FIG. 5A will result in the same summary table rows 206 being displayed in the summary table 204. In another embodiment, while the filter expressions corresponding to the two multi-condition data filters may be logically equivalent, the intended result may be different, and the summary table data filter module 118 may apply these filter expressions in a particular order so that the summary table rows 206 displayed in the summary table 204 satisfy the intended outcome, as will be discussed in more detail below in regard to FIG. 9.

According to embodiments, a number of multi-condition data filters may be specified by the user 106 to be applied to the summary table 204. These multi-condition data filters may be applied using separate invocations of the data filter window 302 to specify different data filter types for the same entity or different data filters for different entities. For example, the user 106 may utilize the data filter window 302 to specify a data filter having multiple filter conditions 304 related to the TOTAL SALES value 216A and TOTAL PROFITS value 216B corresponding to each SALESMAN row label 210 in the summary table 204, as discussed above in regard to FIG. 4. This may result in the following filter expression being applied to the summary table 204:

((TOTAL SALES is less than 125,000 OR TOTAL SALES is greater than 150,000) AND TOTAL PROFITS is greater than 0)

In addition, the user 106 may further utilize the data filter window 302 to specify a data filter limiting the displayed rows to the SALESMAN row labels 210 having the top two corresponding TOTAL SALES values 216A. This may result in the following filter expression being further applied to the summary table 204:

(Top 2 items by TOTAL SALES)

It will be appreciated that the order of application of the two multi-condition data filters described above to the summary data may affect the resulting summary table rows 206 that are displayed in the summary table 204. Accordingly, the data analysis program 104 may provide an additional UI, such as the UI 600 shown in FIGS. 6A and 6B, that allows the user 106 to both see the various multi-condition data filters currently applied to the summary table 204 as well as change the order of their application, according to one embodiment. As shown in FIG. 6A, the UI 600 includes a data filter ordering window 602 that contains a list of the data filter expressions 604A, 604B corresponding to the two multi-condition data filters applied to the summary data, as described above.

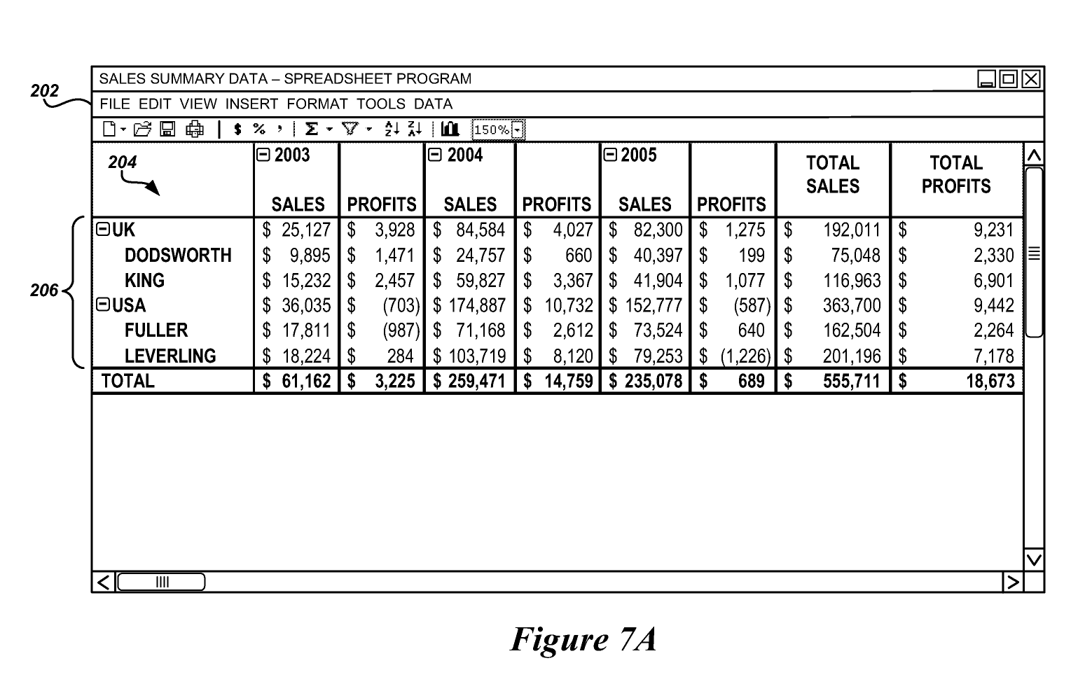

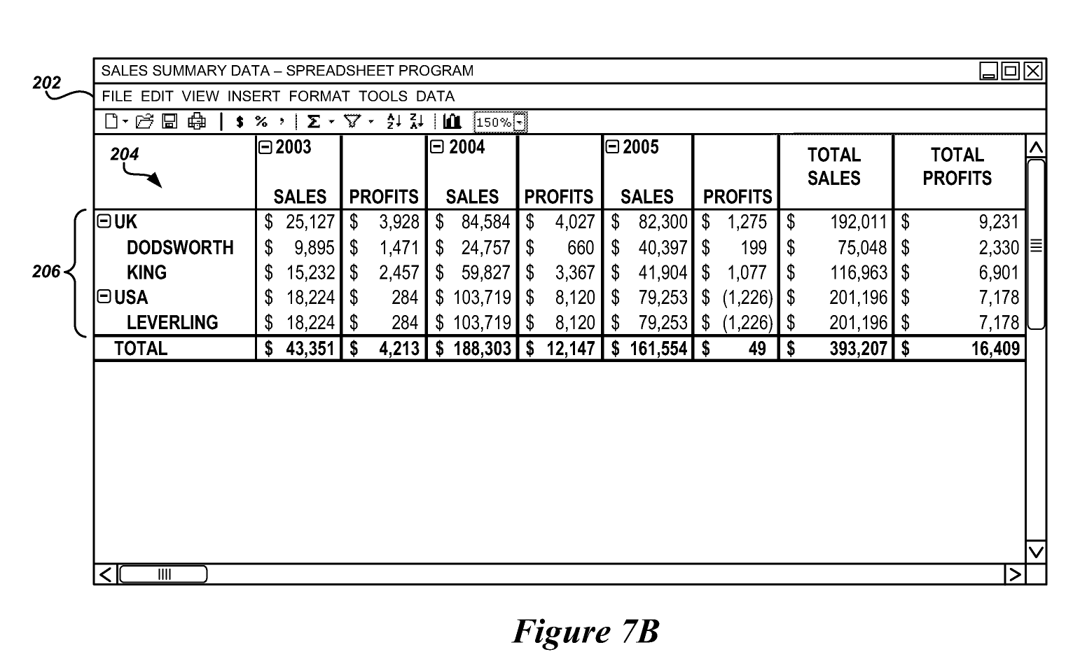

The data filter expressions 604A, 604B are listed in the current order of application to the summary data, with the multi-condition data filter related to the TOTAL SALES value 216A and TOTAL PROFITS value 216B applied first, and the data filter related to the top two SALESMAN rows applied second. If the listed data filters were applied in the listed order to the summary table 204 described above in regard to FIG. 2, the resulting summary table rows 206 displayed may be as shown in FIG. 7A.

As shown in FIG. 7A, the rows 206 displayed in the summary table 204 consist of the top two SALESMAN row labels 210 by TOTAL SALES from the set of SALESMAN row labels having corresponding TOTAL SALES values 216A less than 125,000 or greater than 150,000 and TOTAL PROFITS values 216B greater than zero. It will be appreciated that, in traditional summary table implementations, the data filters may be applied to each subgroup of rows corresponding to different parent row labels in an existing hierarchy. For example, as shown in FIG. 6A, the data filter is applied separately to the SALESMAN row labels 210 that rollup to the COUNTRY field value of “UK,” and the SALESMAN row labels that rollup to the COUNTRY field value of “US.”

The data filter ordering window 602 also contains an “up” reorder filter UI control 606 and a “down” reorder filter UI control 608, as further shown in FIG. 6A. These UI controls 606, 608 may be utilized by the user 106 to change the order of application of the multi-condition data filters to the summary data. For example, the user 106 may select the first data filter expression 604A in the data filter ordering window 602 shown in FIG. 6A, as indicated by the selection box 502, by utilizing the input devices 116 connected to the computer 102. If the user then utilizes the “down” reorder filter UI control 608 to move the first data filter expression 604A down in the listed order, the data filter expressions 604B, 604A may then be listed in the data filter ordering window 602 as shown in FIG. 6B.

If data filter expressions 604B, 604A were applied in the order shown in FIG. 6B to the summary table 204 described above in regard to FIG. 2, the resulting summary table rows 206 displayed may be as shown in FIG. 7B. As shown in FIG. 7B, the rows 206 displayed in the summary table 204 consist of consist of the top two SALESMAN row labels 210 by TOTAL SALES having TOTAL SALES values 216A less than 125,000 or greater than 150,000 and TOTAL PROFITS values 216B greater than zero. As is shown in the figures, the application of the multi-condition data filters in the order shown FIG. 6B results in the exclusion of the SALESMAN row label 210 with the value of “FULLER,” which is included in the rows 206 of the summary table 204 shown in FIG. 6A. It will be appreciated that the difference between the two resulting displayed rows 206 in FIGS. 7A and 7B may arise from the different ordering of the data filters in the data filter ordering window 602 described above in regard to FIGS. 6A and 6B.

FIGS. 8A and 8B show a further embodiment of a UI 800 presented by the summary table UI module 112 that allows the user 106 to specify a multi-condition data filter. As described above, the data analysis program 104 may provide the user 106 with the ability to group filter conditions 304 together in order to modify the order of evaluation of the logical operators. The data filter window 302 shown in FIG. 8A includes a group conditions UI control 802 and an ungroup conditions UI control 804 which may be utilized by the user 106 to group and ungroup filter conditions 304, respectively.

For example, the user 106 may select the second filter condition 304B and the third filter condition 304C in the data filter window 302 shown in FIG. 8A, as indicated by the selection box 502, by utilizing the input devices 116 connected to the computer 102. If the user then utilizes the group conditions UI control 802 to group the selected filter conditions 304B and 304C together, the resulting filter expression corresponding to the data filter specified in the data filter window 302 would be:

((SALESMAN contains “A” AND (SALESMAN is between “C” and “F” OR SALESMAN equals “LEVERLING”)) AND SALESMAN is less than “Z”)

It will be appreciated that this filter expression may be evaluated differently by the summary table data filter module 118 than the filter expression corresponding to the same four filter conditions 304A-304D specified in the data filter window 302 described above in regard to FIG. 3.

According to one embodiment, the summary table UI module 112 indicates the currently grouped filter conditions 304B and 304C in the data filter window 302 by adding a graphical grouping display 806 to the window in conjunction with the display of the filter conditions 304, as further shown in FIG. 8A. It will be appreciated that other forms of the graphical grouping display 806 may be utilized by the summary table UI module 112, including, but not limited to, the display of parenthesis around the grouped filter conditions 304 corresponding the currently specified groupings.

By way of an additional example, the user 106 may further select the second filter condition 304B, the third filter condition 304C, and the fourth filter condition 304D in the data filter window 302, as indicated by the selection box 502 shown in FIG. 8B. If the user 106 then utilizes the group conditions UI control 802 to group the selected filter conditions 304B, 304C, and 304D, the data filter window 302 would contain two nested groups, with a resulting filter expression of:

(SALESMAN contains “A” AND ((SALESMAN is between “C” and “F” OR SALESMAN equals “LEVERLING”) AND SALESMAN is less than “Z”))

In addition, the summary table UI module 112 may update the graphical grouping display 806 to indicate the two nested groups of filter conditions 304B and 304C and filter conditions 304B, 304C, and 304D, created by the user in the data filter window 302, as further shown in FIG. 8B. It will be further appreciated that an unlimited number of nested groups amongst filter conditions 304 may be supported by the data analysis program 104, beyond those shown in FIGS. 8A and 8B and described herein.

Referring now to FIG. 9, additional details will be provided regarding the embodiments presented herein. It should be appreciated that the logical operations described with respect to FIG. 9 are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as operations, structural devices, acts, or modules. These operations, structural devices, acts, and modules may be implemented in software, in firmware, in special purpose digital logic, and any combination thereof. It should also be appreciated that more or fewer operations may be performed than shown in the figures and described herein. The operations may also be performed in a different order than described.

FIG. 9 illustrates a routine 900 for filtering summary data based on one or more multi-condition data filters for display in a summary table 204 on a display device 114. The routine 900 begins at operation 902, where the summary table data filter module 118 receives summary data to be filtered and displayed in the summary table 204. The summary table data filter module 118 may receive the summary data from the summary table data access module 110. As described above in regard to FIG. 1, the summary table data access module 110 retrieves source data from the data source 108 and transforms the source data through summarization functions into the summary data.

From operation 902, the routine 900 proceeds to operation 904, where the summary table data filter module 118 receives the specification of one or more multi-condition data filters. According to one embodiment, the multi-condition data filters are specified by the user 106 interactively using the data filter window 302 provided by the summary table UI module, as described in detail above in regard to FIGS. 3, 4, 5A, 5B, 8A, and 8C. The specification of the multi-condition data filters may include one or more filter conditions 304, specified in a particular order, with each filter condition 304 connected by a specified logical operator, such as “AND” and “OR.” Additionally, the filter conditions may be grouped together in one or more nested groups, according to one embodiment.

The routine 900 proceeds from operation 904 to operation 906, where the summary table data filter module 118 parses the filter expressions from the data filters specifications received in operation 904. The filter expression parsed from a multi-condition data filter will depend upon the individual filter conditions 304 specified in the data filter, the logical operators connecting the filter conditions, the order in which the filter conditions were specified, and any groupings specified between filter conditions. For example, the multi-condition data filter specified in data filter window 302 shown in FIG. 3 described above may be parsed by the summary table data filter module 118 resulting in a filter expression of:

(((SALESMAN contains “A” AND SALESMAN is between “C” and “F”) OR SALESMAN equals “LEVERLING”) AND SALESMAN is less than “Z”)

This expression results from the order of the filter conditions 304 and the logical operators specified between each filter condition. Here, default grouping is applied in the absence of any specified groupings.

Similarly, the multi-condition data filter specified in data filter window 302 shown in FIG. 8B described above may be parsed to a filter expression of:

(SALESMAN contains “A” AND ((SALESMAN is between “C” and “F” OR SALESMAN equals “LEVERLING”) AND SALESMAN is less than “Z”))

This variation of the filter expression from the same four filter conditions 304A, 304B, 304C, and 304D used above results from the specification by the user 106 of the two nested groups of filter conditions 304B and 304C, and filter conditions 304B, 304C, and 304D, made in the data filter windows 302.

According to one embodiment, the parsing of certain multi-condition data filters may result in multiple, separate filter expressions, because of the need for the filter expressions to be applied sequentially to the summary data. For example, the multi-condition data filter specified in the data filter window 302 shown in FIG. 5A described above may result in the filter expressions:

(PROFITS is greater than 0)

and

(Top 2 items by SALES)

In this case, the filter expressions should be applied sequentially: the set of SALESMAN rows where the TOTAL PROFITS 216B are greater than zero established first, and then the top two SALESMAN rows by TOTAL SALES value 216A selected from that set.

From operation 906, the routine 900 proceeds to operation 908, where the summary table data filter module 118 determines the order in which to apply the filter expressions parsed from the multi-condition data filters in operation 906 above. The order of application of the multi-condition data filters may be based on the order in which the data filters were created by the user 106, or the order may be specified by the user using the UI 600 discussed above in regard to FIGS. 6A and 6B. It will be appreciated that the order in which the filter expressions are to be applied may further depend on a number of factors, including, but not limited to, the relationship between the data fields to which the data filters are applied, a default preference of row data filters over column data filters, or some other factor. In addition, as described above in regard to operation 906, the summary table data filter module 118 may sequentially order multiple filter expressions resulting from a single multi-condition data filter based on the order in which the filter conditions 304 were specified by the user 106.

Next, the routine 900 proceeds from operation 908 to operation 910, where the summary table data filter module 118 applies the filter expressions parsed from the multi-condition data filters to the summary data in the order established in operation 908 above. When multiple filter expressions are to be applied in a specific order, the summary table data filter module 118 may be required to recalculate aggregate summary values, such as row and column totals as well subtotals in any hierarchies displayed in the summary table 204, between the application of each filter expression. In other words, the input to a subsequent filter expression is the result of the application of a previous filter expression with any aggregate values recalculated after the application of the previous filter expression. This may be accomplished by applying a methodology similar to that described in U.S. Patent Pub. No. US 2006-0287998 A1, filed on Jun. 21, 2005, and entitled “Dynamically filtering Aggregate Reports Based on Values Resulting from One or More Previously Applied Filters,” which is expressly incorporated herein by reference in its entirety.

From operation 910, the routine 900 proceeds to operation 912, where the summary table data filter module 118 passes the filtered summary data to a display module, such as the summary table UI module described above in regard to FIG. 1, for display of the summary table 204 on the display device 114. From operation 912, the routine 900 ends.

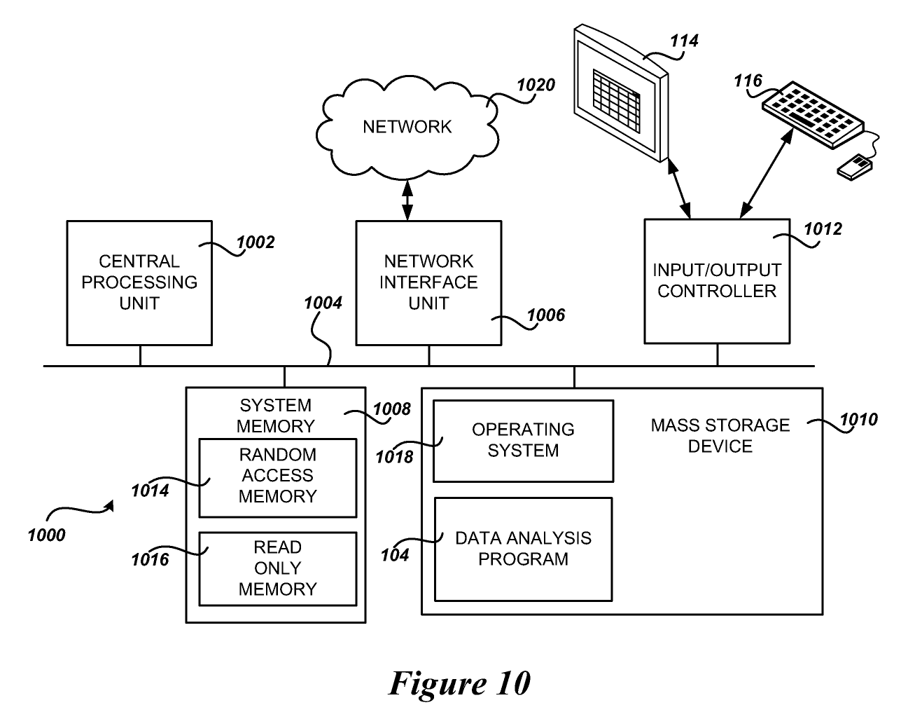

FIG. 10 shows example computer architectures for a computer 1000 capable of executing the software components described herein for providing multi-condition filtering of an interactive summary table, in the manner presented above. The computer architecture shown in FIG. 10 illustrates a conventional computing device, PDA, digital cellular phone, communication device, desktop computer, laptop, or server computer and may be utilized to execute any aspects of the software components presented herein described as executing on the computer 102 or other computing platform.

The computer architecture shown in FIG. 10 includes a central processing unit 1002 (CPU), a system memory 1008, including a random access memory 1014 (RAM) and a read-only memory 1016 (ROM), and a system bus 1004 that couples the memory to the CPU 1002. A basic input/output system containing the basic routines that help to transfer information between elements within the computer 1000, such as during startup, is stored in the ROM 1016. The computer 1000 also includes a mass storage device 1010 for storing an operating system 1018, application programs, and other program modules, which are described in greater detail herein.

The mass storage device 1010 is connected to the CPU 1002 through a mass storage controller (not shown) connected to the bus 1004. The mass storage device 1010 and its associated computer-readable media provide non-volatile storage for the computer 1000. Although the description of computer-readable media contained herein refers to a mass storage device, such as a hard disk or CD-ROM drive, it should be appreciated by those skilled in the art that computer-readable media can be any available computer storage media that can be accessed by the computer 1000.

By way of example, and not limitation, computer-readable media may include volatile and non-volatile, removable and non-removable media implemented in any method or technology for storage of information such as computer-readable instructions, data structures, program modules, or other data. For example, computer-readable media includes, but is not limited to, RAM, ROM, EPROM, EEPROM, flash memory or other solid state memory technology, CD-ROM, digital versatile disks (DVD), HD-DVD, BLU-RAY, or other optical storage, magnetic cassettes, magnetic tape, magnetic disk storage or other magnetic storage devices, or any other medium that can be used to store the desired information and that can be accessed by the computer 1000.

According to various embodiments, the computer 1000 may operate in a networked environment using logical connections to remote computing devices and computer systems through a network 1020. The computer 1000 may connect to the network 1020 through a network interface unit 1006 connected to the bus 1004. It should be appreciated that the network interface unit 1006 may also be utilized to connect to other types of networks and remote computer systems. The computer 1000 may also include an input/output controller 1012 for receiving and processing input from a number of input devices 116, including a keyboard, a mouse, a touchpad, a touch screen, an electronic stylus, or other type of input device. Similarly, the input/output controller 1012 may provide output to a display device 114, such as a computer monitor, a flat-panel display, a digital projector, a printer, a plotter, or other type of output device.

As mentioned briefly above, a number of program modules and data files may be stored in the mass storage device 1010 and RAM 1014 of the computer 1000, including an operating system 1018 suitable for controlling the operation of a computer. The mass storage device 1010 and RAM 1014 may also store one or more program modules. In particular, the mass storage device 1010 and the RAM 1014 may store the data analysis program 104, which was described in detail above in regard to FIG. 1. The mass storage device 1010 and the RAM 1014 may also store other types of program modules or data. In one embodiment, the program modules are embodied in computer-readable media containing instructions that, when executed by the CPU 1002, perform the routine 900 for filtering summary data based on one or more multi-condition data filters for display in a summary table, as described in greater detail above in regard to FIG. 8.

Based on the foregoing, it should be appreciated that technologies for providing multi-condition filtering of an interactive summary table are provided herein. Although the subject matter presented herein has been described in language specific to computer structural features, methodological acts, and computer-readable media, it is to be understood that the invention defined in the appended claims is not necessarily limited to the specific features, acts, or media described herein. Rather, the specific features, acts, and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed is:

1. A computer-implemented method for providing multi-condition filtering of summary data displayed in a summary table on a display device connected to a computer, the method comprising:
displaying on the display device a user interface allowing a user of the computer to specify a multi-condition data filter;
receiving from the user interface a specification for the multi-condition data filter comprising a plurality of filter conditions connected by logical operators;
parsing one or more filter expressions from the specification based on the plurality of filter conditions and the logical operators;
applying the one or more filter expressions to the summary data; and
displaying the filtered summary data in the summary table on the display device.

2. The computer-implemented method of claim 1, wherein the user interface comprises a means for adding filter conditions to the plurality of filter conditions and deleting filter conditions from the plurality of filter conditions.

3. The computer-implemented method of claim 2, wherein the user interface further comprises a means for selecting the logical operators connecting adjacent filter conditions in the plurality of filter conditions.

4. The computer-implemented method of claim 2, wherein the user interface further comprises a means for ordering the plurality of filter conditions in a specific order.

5. The computer-implemented method of claim 4, wherein the specification of the multi-condition data filter further comprises the specific order of the plurality of filter conditions and wherein the one or more filter expressions are further based on the specific order of the plurality of filter conditions.

6. The computer-implemented method of claim 2, wherein the user interface further comprises a means for grouping a subset of the plurality of filter conditions into one or more groupings of filter conditions.

7. The computer-implemented method of claim 6, wherein the specification of the multi-condition data filter further comprises the one or more groupings of filter conditions and wherein the one or more filter expressions are further based on the one or more groupings of filter conditions.

8. The computer-implemented method of claim 6, wherein the user interface further comprises a means for showing the one or more grouping of filter conditions in conjunction with a display of the plurality of filter conditions.

9. The computer-implemented method of claim 1, further comprising:
receiving from the user interface specifications for a plurality of multi-condition data filters;
receiving from the user interface an order of application of the plurality of multi-condition data filters; and
applying the one or more filter expressions in an order based at least in part on the order of application of the plurality of multi-condition data filters.

10. The computer-implemented method of claim 9, further comprising recalculating aggregate totals within the summary data between each successive application of the one or more filter expressions.

11. The computer-implemented method of claim 1, wherein the method is performed by a spreadsheet program operating on the computer.

12. A computer-readable medium having computer executable instructions stored thereon that, when executed by a computer, cause the computer to:
receive summary data;
receive a specification for a multi-condition data filter, the specification comprising a plurality of filter conditions connected by logical operators;
parse one or more filter expressions from the specification based on the plurality of filter conditions and the logical operators;
apply the one or more filter expressions to the summary data; and
pass the filtered summary data to a display module for display of a summary table on a display device connected to the computer.

13. The computer-readable medium of claim 12, wherein the specification of the multi-condition data filter further comprises a specified order of the plurality of filter conditions and wherein the one or more filter expressions is further based on the specified order of the plurality of filter conditions.

14. The computer-readable medium of claim 12, wherein the specification of the multi-condition data filter further comprises one or more groupings of filter conditions and wherein the one or more filter expressions is further based on the one or more groupings of filter conditions.

15. The computer-readable medium of claim 12, having additional computer executable instructions stored thereon that, when executed by the computer, further cause the computer to:
receive specifications for a plurality of multi-condition data filters;
receive an order of application of the plurality of multi-condition data filters;
parse one or more filter expressions from the specifications;
upon parsing the one or more filter expressions from the specifications, determine an order of application of the one or more filter expressions based at least in part on the order of application of the plurality of multi-condition data filters; and
apply the one or more filter expressions to the summary data in the determined order of application.

16. The computer-readable medium of claim 15, wherein aggregate totals within the summary data are recalculated between each successive application of the one or more filter expressions.

17. The computer-readable medium of claim 12, wherein the computer executable instructions are included in a spreadsheet program.

18. A system for providing multi-condition data filtering of summary data displayed in a summary table, the system comprising:
a computer;
a display device operably connected to the computer;
a first user interface that allows a user to specify a multi-condition data filter comprising a plurality of filter conditions connected by logical operators;
a summary table data access module operative to access source data from a data source (108) and transform the source data into summary data;
a summary table UI module operative to:
display the first user interface on the display device,
receive a specification of a multi-condition data filter from the first user interface, and
display the filtered summary data on the display device in a summary table; and
a summary table data filter module operative to:
parse one or more filter expressions from the specification of the multi-condition data filter based on the plurality of filter conditions and the logical operators,
determine an order of application of the one or more filter expressions, and
apply the one or more filter expressions to the summary data in the determined order of application.

19. The system of claim 18, further comprising a second user interface that allows a user to specify an order of application of a plurality of multi-condition data filters, wherein the summary table UI module is further operative to display the second user interface on the display device and receive the order of application of the plurality of multi-condition data filters, and wherein determining the order of application of the one or more filter expressions further comprises determining the order of application of the one or more filter expressions based at least in part on the order of application of the plurality of multi-condition data filters.

20. The system of claim 18, wherein the summary table data access module, the summary table data filter module, and the summary table UI module are components of a spreadsheet program.
